(19) United States
(12) Patent Application Publication
(10) Pub. No.: US 2010/0123799 A1
(43) Pub. Date: May 20, 2010

(54) IMAGE CAPTURING APPARATUS

(75) Inventors: Yen-Chao Chen, Taichung (TW); Jung-Ching Wang, Taichung (TW); Hsih-Hsien Yang, Taichung (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ASIA OPTICAL CO., INC., Taichung (TW)

(21) Appl. No.: 12/555,099

(22) Filed: Sep. 8, 2009

(30) Foreign Application Priority Data
Nov. 19, 2008 (TW) 97144752

(51) Int. Cl. H04N 5/76; H04N 5/222; H04N 5/225

(52) U.S. Cl. 348/231.99; 348/333.01; 348/372; 348/E05.022; 348/E05.024

(57) ABSTRACT

An image capturing apparatus connectable to a display device is provided, including: an image capturing unit to capture and output image data; a recording unit to record image data and parameter data of the display; a command unit to generate a command signal while the display device is connected; a interface connectable to the display of the display device; a power supply unit to supply power for the display via the interface while receiving a power supply signal; and a processing/control unit to generate and output the power supply signal to the power supply unit while receiving the command signal and transmit parameter data and image data to the display via the interface, providing a plug and play function for the display.

### CROSS REFERENCE TO RELATED APPLICATIONS

This Application claims priority of Taiwan Patent Application No. 97144752, filed on Nov. 19, 2008, the entirety of which is incorporated by reference herein.

### BACKGROUND OF THE INVENTION

1. Field of the Invention

The present invention relates to an image capturing apparatus, and more particularly to an image capturing apparatus having a plug and play interface.

2. Description of the Related Art

Digital photo technology is currently very popular when compared to conventional photo technology. Thus, digital cameras are commonly used to record images for capturing pictures. Some digital camera trends include, light weight, low battery power consumption and long battery operating life to provide long use time for a user. Digital cameras provide viewing of captured images via displays thereof. However, when viewing captured images through displays of digital cameras, much power is consumed. Meanwhile, different sized displays of digital cameras are used for different functions. For example, some outdoor digital cameras are used mainly to record ecological happenings, and images are needed to be captured, but not necessarily immediately viewed. Due to harsh environmental factors, displays of the outdoor digital cameras may be easily damaged during long outdoor operation.

### BRIEF SUMMARY OF THE INVENTION

The invention provides an image capturing apparatus having a plug and play interface.

The invention provides an image capturing apparatus connected to a display device and comprising an image capturing unit to capture and output image data, a recording unit to record image data and parameter data of the display device, a command unit to generate a command signal while the display device is connected, a plug and play interface connectable to the display device, a power supply unit to supply power for the display device via the plug and play interface while receiving a power supply signal, and a processing/control unit to generate and output the power supply signal to the power supply unit while receiving the command signal, and transmit parameter data and image data to the display device via the plug and play interface.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a block view of a display device and an image capturing apparatus having a plug and play interface of the present invention;

FIG. 2 is a schematic view of the image capturing apparatus assembled to a display device of the present invention;

FIG. 3A is a schematic view showing a switch circuit of the invention;

FIG. 3B is a schematic view showing a switch circuit of another embodiment of the invention;

FIG. 4 is a schematic view of a command unit of another embodiment of the invention;

FIG. 5A is a schematic view of a switch circuit of another embodiment of the invention; and

FIG. 5B is a schematic view of a switch circuit when a display device is assembled to an image capturing device 10 of the present invention.

### DETAILED DESCRIPTION OF THE INVENTION

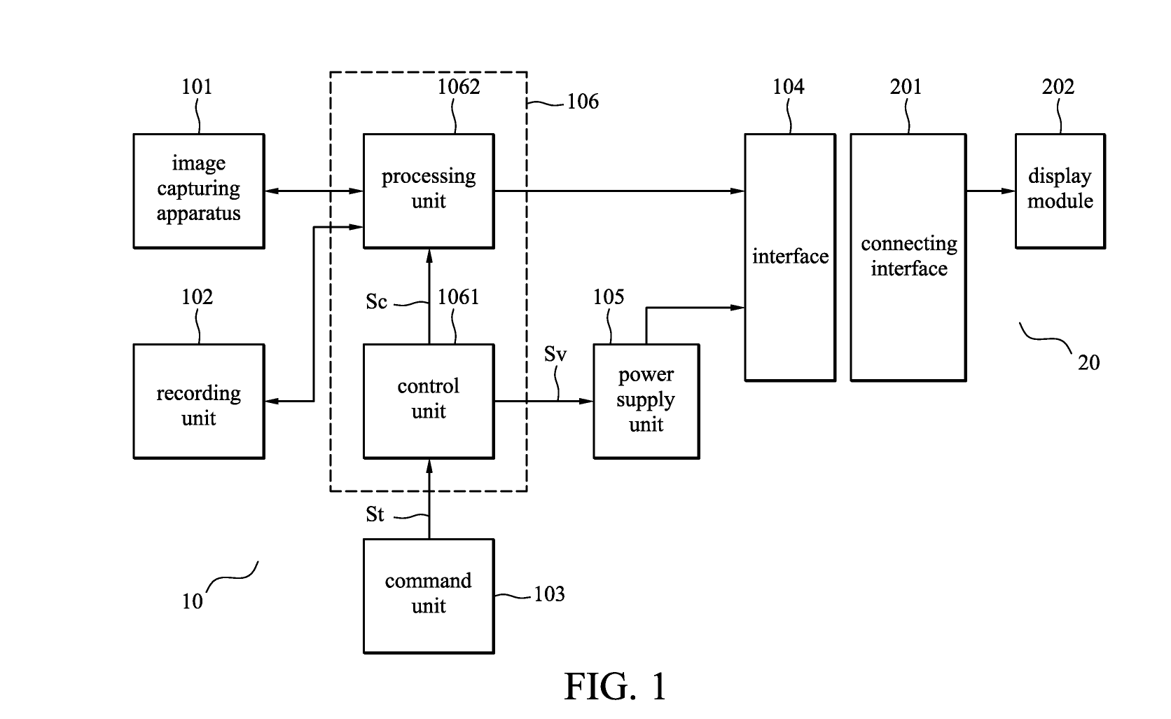

Referring to FIG. 1, FIG. 1 is a block view of a display device 20 and an image capturing apparatus 10 having a interface of the present invention. The image capturing apparatus 10 is connected to the display device 20 via the interface. The display device 20 comprises a connecting interface 201 and a display module 202 coupled to the connecting interface 201. The display module 202 receives parameter data, image data and power for the display module 202 via the connecting interface 201.

The image capturing apparatus 10 comprises an image capturing unit 101, a recording unit 102, a command unit 103, a interface 104 connectable to the display device 20, a power supply unit 105, and a processing/control unit 106.

The image capturing unit 101 captures and outputs image data. The image capturing unit 101 further comprises a lens (not shown) and an imaging sensor module (not shown). When the image capturing unit 101 executes image capturing, light reflected by objects passing through the lens, arrive at the imaging sensor module. The imaging sensor module senses the light and outputs image data in accordance with the light intensity. The imaging capturing module may be a CCD or a CMOS module.

The recording unit 102 records image data captured by the image capturing unit 101 and parameter data of the display device 20. While the image capturing unit 101 is outputting image data, the processing/control unit 106 proceeds with image processing and compresses the image data and saves it in the recording unit 102. The recording unit 102 also had been recorded with the parameter data initializing the display device 20. When the display device 20 is initialized in accordance with the parameter data, for example dots per inch, brightness, contrast, and data form of the display device 20. In this embodiment, the recording unit 102 is a non-volatile random access memory, for example a flash memory. In another embodiment, the recording unit 102 is a hard disc.

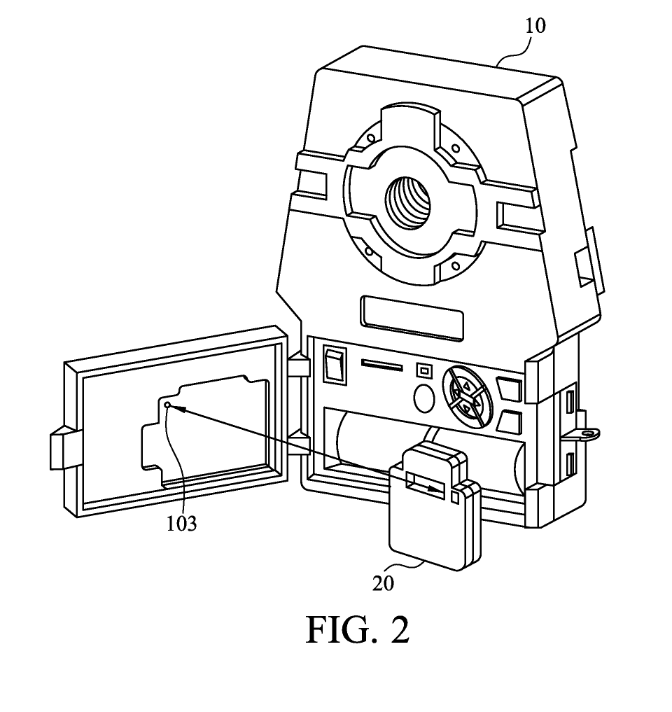

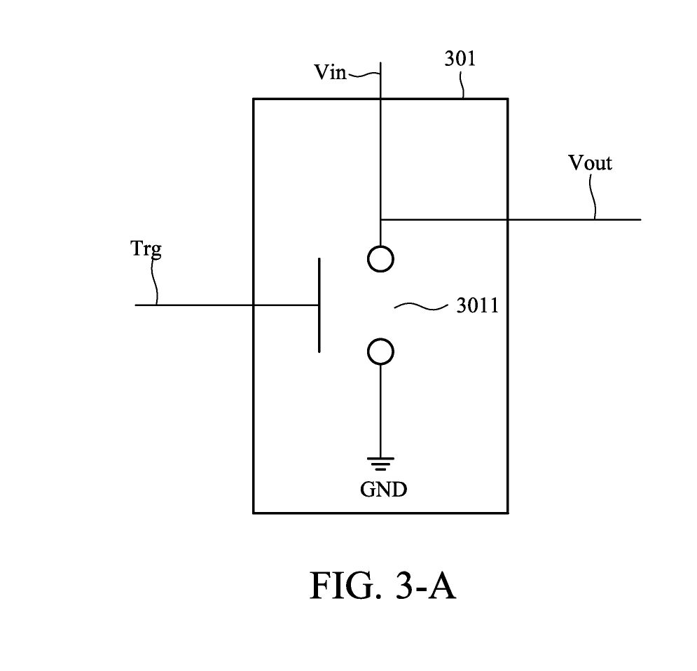

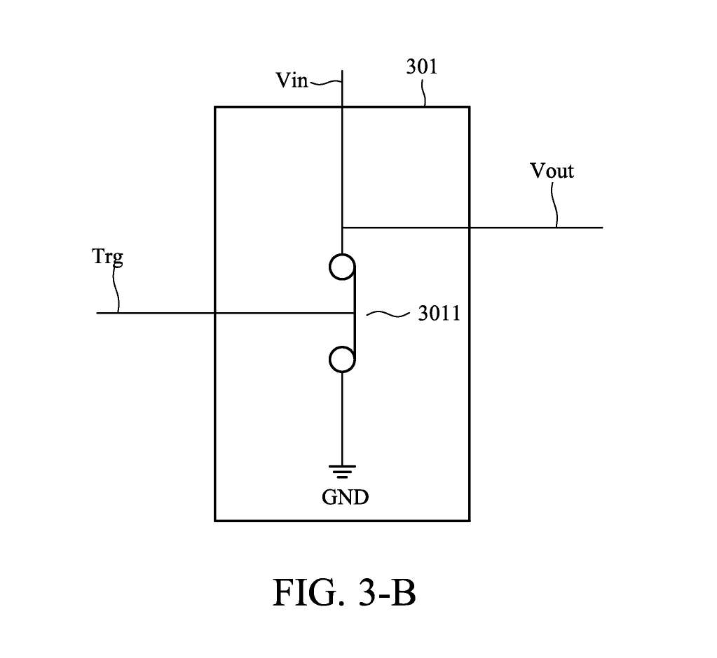

The command unit 103 generates a command signal St while the display device 20 is connected. Referring to FIG. 2, FIG. 2 is a schematic view of the image capturing apparatus 10 assembled to a display device 20 of the present invention. When the display device 20 is assembled to the image capturing apparatus 10, the display device 20 will contact with the command unit 103 for generating the command signal. Specifically, in this embodiment, the command unit 103 is a switch circuit. Shown in FIG. 3A, FIG. 3A is a schematic view showing a switch circuit of the invention. The switch circuit 301 comprises a switch 3011 connected to a contacting end Trg, a voltage input Vin coupled to a reference voltage and a voltage output Vout coupled to the processing/control unit 106. When the contacting end Trg is contacted, for example pressed, the switch 3011 is switched to be short circuit. The switch 3011 is coupled to the voltage input Vin and connected to the ground GND. If the display device 20 is not assembled to the image capturing device 10, the switch 3011 is open circuit. Thus, the voltage output Vout is equal to the reference voltage. When the display device 20 is assembled to the image capturing device 10, the contacting end Trg is pressed to allow short circuit of the switch 3011. Thus, the voltage of the voltage output Vout is changed from high level to low level so that generate the command signal St, representing that the display device being connected to the image capturing device 10. The switch 3011 is a normal open switch. Referring to FIG. 3B, FIG. 3B is a schematic view showing a switch circuit of another embodiment of the invention. The difference with FIG. 3B and 3A is that when the contacting end Trg is pressed, the switch 3011 is open circuit. When the display device 20 is assembled to the image capturing device 10, the contacting end Trg is pressed to make the switch 3011 open circuit. Thus, the voltage of the voltage output Vout is changed from low level to the reference voltage so that the command signal St is generated, representing that the display device is connected to the image capturing device 10. The switch 3011 is a normal closed switch.

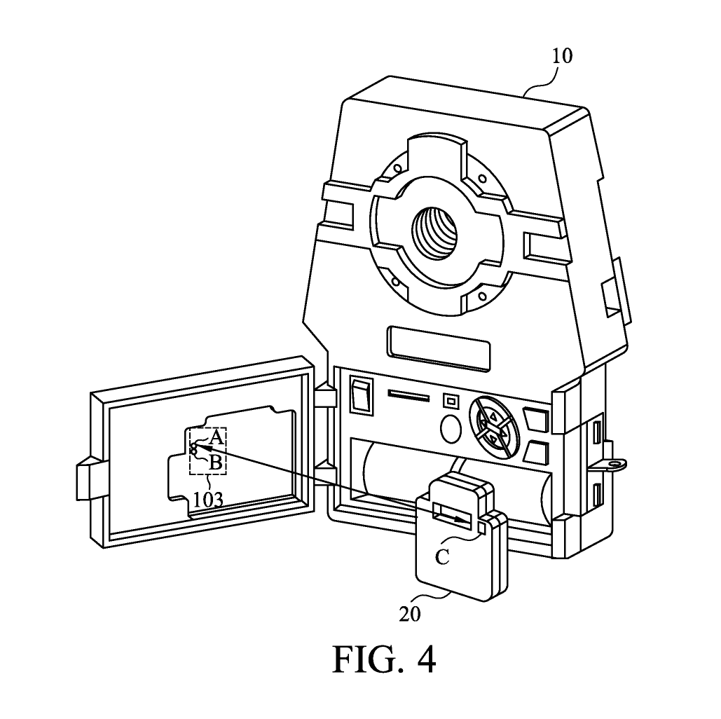

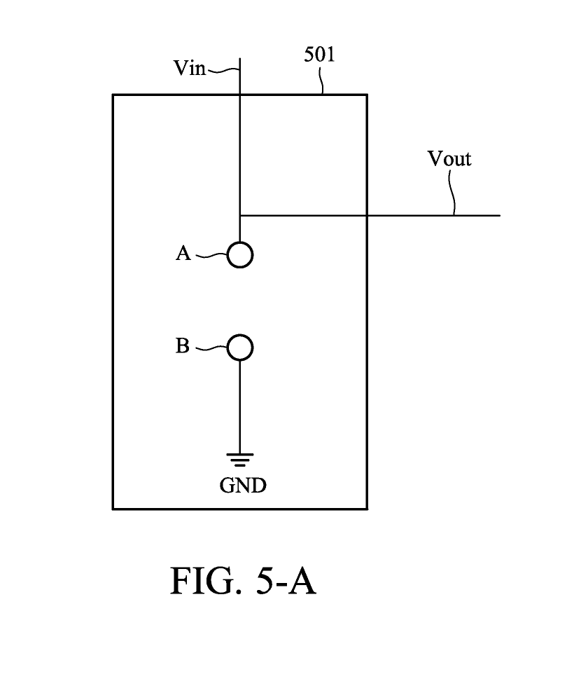

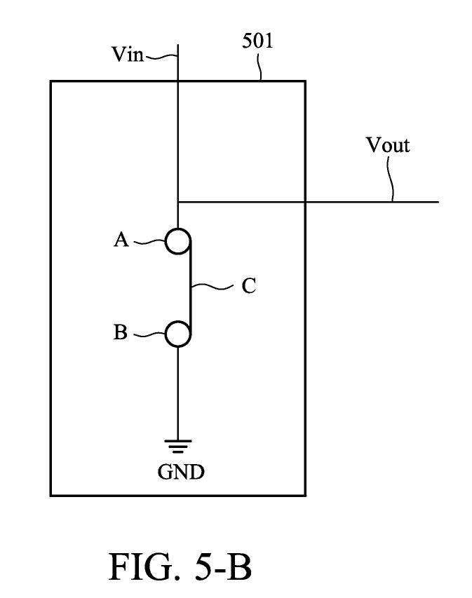

Referring to FIG. 4, FIG. 4 is a schematic view of a command unit 103 of another embodiment of the invention. The command unit 103 installed on the image capturing device 10 comprises a first conductive end A and a second conductive end B with two intervals. An electric conductor C, for example of copper, iron or tin material, is installed on the display device 20. In this embodiment, the command unit 103 is an swithch circuit 5011. Referring to FIG. 5A, FIG. 5A is a schematic view of a switch circuit of another embodiment of the invention. The first conductive end A couples to the voltage input Vin and the voltage output Vout. The voltage input Vin receives a reference voltage. The second conductive end B is connected to the ground. Thus, for switch circuit 501 of FIG. 5A, the voltage of the voltage output Vout is equal to the reference voltage. If the display device 20 is assembled to the image capturing device 10, the electric conductor C is simultaneously connected to the first conductive end A and the second conductive end B to short the circuits. FIG. 5B is a schematic view of a switch circuit 501 when a display device 20 is assembled to an image capturing device 10. When the electric conductor C makes the first conductive end A and the second conductive end B short circuit, the voltage of the voltage output Vout reduces from the reference voltage to a low level to generate the command signal St.

The interface 104 is used for connecting the display device 20 and image capturing device 10. The interface 104 is coupled to the power supply unit 105 and the processing/control unit 106 and is used to be a communicate and connect interface between the image capturing device 10 and the display device 20 and supply power provided by the power supply unit 105 of the image capturing device 10 to the display device 20. In this embodiment, the interface 104 is a bus.

When the power supply unit 105 receives a power supply signal Sv, the power is provided by the power supply unit to the display device 20 throughout the interface 104. The power supply unit 105 is coupled to the processing/control unit 106. When the power supply unit 105 receives the power supply signal Sv from the processing/control unit 106, the power outputted from the power supply unit 105 is started to provide to the display device 20 throughout the interface 104 of the image capturing device 10. Thus, a required power of the display device 20 can be supported throughout the interface 104 of the image capturing device 10 when the display device 20is connected to the image capturing device 10. In this embodiment, the power supply unit 105 is a power supply IC.

When the processing/control unit 106 receives the command signal St, the power supply signal Sv is generated and output to the power supply unit 105, and parameter data and image data are transmitted to the display device 20 via the interface 104. The processing/control unit 106 further comprises a control module 1061 and a processing module 1062. The control module 1061 is coupled to the command unit 103 and power supply unit 105. Specifically, when the control module 1061 receives the command signal St, a power supply signal Sv and a control signal Sc are generated and outputted. The processing module 1062 couples to the control module 1061, the image capturing unit 101, and the interface 104 to transmit parameter data to the interface 104 while receiving the control signal. Image data is also transmitted to the interface 104 after processing of the image data.

Specifically, when the image capturing device 10 is connected to the display device 20, the command unit 103 generates the command signal St due to that the display device 20 contact with the command unit 103. When the control module receives the command signal St, the power supply signal Sv is generated and then transmitted to the power supply unit 105. Thus, the power supply unit 105 starts to supply power via the interface 104. Because the display device 20 is connected to the image capturing device 10 via the interface 104, the display device 20 receives power from the power supply unit 105 of the image capturing device 10 and then the display device 20 is started. After the processing module 1062 receives the control signal Sc, parameter data is saved in the recording unit 102, and the initial set of the display device 20 starts for setting the value of the display device 20; for example, dots per inch, horizontal synchronization input signal and vertical synchronization input signal. Then, the processing module 1062 transmits the image data captured by the image capturing device 101 or the image data saved by recording unit 102 to the display device 20 via the interface 104 for display and browsing the images or providing a user for image proceeding, for example to delete the images.

In this embodiment, the control module 1061 is a micro control unit, MCU. The processing module 1062 is a digital signal processor (DSP). In an embodiment, the control module 1061 is a DSP, a complex programmable logic device (CPLD), a field programmable gate array (FPGA), a central processing unit (CPU), or a system on chip (SOC). In another embodiment, the processing/control unit 106 is a DSP.

Note that the display device 20 of this embodiment comprises a connecting interface. The hardware set data and the displayed image data are transmitted to outside devices via the connecting interface 201 for connection and communication. Power is supplied from the outside power source via the connecting interface 201. In this embodiment, the display device 20 is a thin film transistor-liquid crystal display (TFT-LCD).

The invention provides an image capturing device 10 having a interface. The interface may be connected to the display device 20 having the connecting interface 201. The command unit 103 may detect if the display device 20 is connected. When the display device 20 is connected to the image capturing device 20, the processing/control unit 106 supplies power and transmits data via the interface 104 for displaying images via the external direct-connect display device 20. Thus, when not showing images, the image capturing device 10 is not connected to the display device 20 to save power that is supplied to the image capturing apparatus 10 and reduce power consumption of the image capturing apparatus 10, thus extending operating life of power supply sources. Because the display device 20 is an external direct-connect device, the space for containing the display device 20 can be deleted. Thus, the volume of the image capturing apparatus 10 is decreased. Additionally, when applying the image capturing apparatus 10 of the invention for outdoor ecological recording, a user only brings the display device 20, thus, damage of the display device 20 due to long term ecological recording is avoided.

The invention makes the image capturing apparatus capable of being attached or being separated with a display device any time, so that disadvantages of conventional image capturing apparatuses are mitigated.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An image capturing apparatus, connected to a display device, comprising:
an image capturing unit, capturing and outputting image data;
a recording unit, recording image data and parameter data of the display device;
a command unit, generating a command signal while the display device is connected;
an interface, using to connect with the display;
a power supply unit, supplying power for the display via the interface while receiving a power supply signal; and
a processing/control unit, generating and outputting the power supply signal to the power supply unit while receiving the command signal, and transmitting parameter data and image data to the display via the interface.

2. The image capturing apparatus as claimed in claim 1, wherein the command unit comprises a switch circuit.

3. The image capturing apparatus as claimed in claim 2, wherein the switch circuit comprises:
a switch, comprising a contacting end, wherein when the contacting end is contacted, the switch is short circuit;
a voltage input, coupled to a reference voltage; and
a voltage output, coupled to the processing/control unit,
wherein the switch is coupled to the voltage input and connected to the ground.

4. The image capturing apparatus as claimed in claim 3, wherein the switch is a normal open switch.

5. The image capturing apparatus as claimed in claim 2, wherein the switch circuit comprises:
a switch, comprising a contacting end, wherein when the contacting end is contacted, the switch is open circuit;
a voltage input, coupled to a reference voltage; and
a voltage output, coupled to the processing/control unit,
wherein the switch is coupled to the voltage input and connected to the ground.

6. The image capturing apparatus as claimed in claim 5, wherein the switch is a normal closed switch.

7. The image capturing apparatus as claimed in claim 1, wherein the interface comprises a bus.

8. The image capturing apparatus as claimed in claim 1, wherein the processing/control unit comprises:
a control module, coupling to the command unit and the power supply unit to generate and output the power supply signal and a control signal; and
a processing module, coupling to the control module, the image capturing unit, the recording unit,and the interface, to transmit parameter data to the interface while receiving the control signal, and to transmit parameter data to the interface after processing image data.

9. The image capturing apparatus as claimed in claim 8, wherein the control module comprises a micro control unit, MCU.

10. The image capturing apparatus as claimed in claim 8, wherein the control module comprises a digital signal processor (DSP), a complex programmable logic device (CPLD), a field programmable gate array (FPGA), a central processing unit (CPU), or a system on chip (SOC).

11. The image capturing apparatus as claimed in claim 8, wherein the control module comprises a digital signal processor (DSP).

12. The image capturing apparatus as claimed in claim 1, wherein the processing/control unit comprises a digital signal processor (DSP).

13. The image capturing apparatus as claimed in claim 1, wherein the recording unit comprises a non-volatile random access memory.

14. The image capturing apparatus as claimed in claim 13, wherein the recording unit comprises a flash memory.

15. The image capturing apparatus as claimed in claim 1, wherein the recording unit comprises a hard disc.

16. The image capturing apparatus as claimed in claim 1, further comprising:
a display, comprising a connecting interface and a display module coupled to the connecting interface, wherein the display module receives parameter data, image data and power for the display module via the connecting interface.

17. The image capturing apparatus as claimed in claim 16, wherein the display comprises an electric conductor and the command unit is an switch circuit, comprising:
a first conductive end, coupled to a voltage input and a voltage output, wherein the voltage input receives a reference voltage; and
a second conductive end, connected to the ground,
wherein when the display is connected to the image capturing apparatus, the electric conductor contacts the first conductive end and the second conductive end to cause a short circuit to generate the command signal.
